(19) United States
(12) Patent Application Publication
(10) Pub. No.: US 2022/0291824 A1
(43) Pub. Date: Sep. 15, 2022

(54) APPARATUS, INFORMATION PROCESSING SYSTEM, AND SOFTWARE FOR PREVENTING HIDING OF OBJECTS ON TOUCH SCREEN FROM VIEW AND CONTROL OF USER

(71) Applicant: FUJIFILM Business Innovation Corp., Tokyo (JP)

(72) Inventor: Hosana KIMURA, Kanagawa (JP)

(73) Assignee: FUJIFILM Business Innovation Corp., Tokyo (JP)

(21) Appl. No.: 17/411,042

(22) Filed: Aug. 24, 2021

(30) Foreign Application Priority Data
Mar. 11, 2021 (JP) 2021-039472

(51) Int. Cl. G06F 3/0488; G06F 3/0484

(52) U.S. Cl. CPC G06F 3/04883; G06F 3/04886; G06F 3/04847; G06F 3/04842

(57) ABSTRACT

An information processing apparatus includes a processor configured to: perform a control for displaying an object to be operated on a display screen, a control for receiving an operation on the object by a first contact that is a contact with the object and a second contact that is a contact with a virtual pointing device by a user, and a control for displaying the virtual pointing device at a predetermined position of the display screen with a predetermined size; and change at least one of the predetermined position, the predetermined size, the first contact, or the second contact, in a case where the virtual pointing device and the object are displayed on the display screen in an overlapping manner.

### CROSS-REFERENCE TO RELATED APPLICATIONS

This application is based on and claims priority under 35 USC 119 from Japanese Patent Application No. 2021-039472 filed Mar. 11, 2021.

### BACKGROUND

### (i) Technical Field

The present invention relates to an information processing apparatus, an information processing system, and a non-transitory computer readable medium storing a program.

### (ii) Related Art

There is a computer device capable of operating an object displayed on a display screen by touching the display screen as well as by using a pointing device. In this case, an intuitive and quick operation may be difficult in the operation using the pointing device. In addition, a detailed operation may be difficult in the touch operation. In a case where the operations are used in combination, the number of times a user's hand moves increases, which may cause an increase of a burden on the user. Therefore, the burden on the user may be reduced by displaying a virtual pointing device on the display screen and operating the device.

JP2014-241139A discloses that a virtual touchpad and a graphical user interface of an operating system are simultaneously displayed on the identical display. In this case, touch input software converts touch packets from user touches into data packets relevant to a screen and display resolution of either the display or a portion of the display displaying the OS. In addition, gesture recognition software applies rules to the converted packets and determines what action the user meant by the touches. Then, an application that controls a mouse cursor operates the mouse cursor according to the mouse action.

### SUMMARY

It is recommended that the user can operate an object to be operated without hiding the object even though the virtual pointing device is displayed on the display screen.

Aspects of non-limiting embodiments of the present disclosure relate to an information processing apparatus, an information processing system, and a non-transitory computer readable medium storing a program that are less likely to hinder an operation of a user on an object even though a virtual pointing device is displayed on a display screen.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a processor configured to: perform a control for displaying an object to be operated on a display screen, a control for receiving an operation on the object by a first contact that is a contact with the object and a second contact that is a contact with a virtual pointing device by a user, and a control for displaying the virtual pointing device at a predetermined position of the display screen with a predetermined size; and change at least one of the predetermined position, the predetermined size, the first contact, or the second contact, in a case where the virtual pointing device and the object are displayed on the display screen in an overlapping manner.

### BRIEF DESCRIPTION OF THE DRAWINGS

Exemplary embodiment(s) of the present invention will be described in detail based on the following figures, wherein:

FIG. 1 is a diagram showing a configuration example of an information processing system according to the present exemplary embodiment;

FIG. 2 is a diagram showing a hardware configuration of an information processing apparatus;

FIG. 3 is a diagram showing a hardware configuration of a display device;

FIG. 4 is a flowchart illustrating an operation of an information processing apparatus according to a first exemplary embodiment;

A part (a) and a part (b) in FIG. 5 are diagrams showing processes performed in Steps S103 to S105 of FIG. 4;

A part (a) and a part (b) in FIG. 6 are diagrams showing a process performed in Step S106 of FIG. 4;

A part (a) and a part (b) in FIG. 7 are diagrams showing another example of the first exemplary embodiment;

A part (a), a part (b), and a part (c) in FIG. 8 are diagrams showing a case where a user sets a position where a virtual trackpad is displayed and a size of the virtual trackpad;

FIG. 9 is a flowchart illustrating an operation of an information processing apparatus according to a second exemplary embodiment;

A part (a), a part (b), and a part (c) in FIG. 10 are diagrams showing a process performed in Step S204 of FIG. 9;

A part (a) and a part (b) in FIG. 11 are diagrams showing an animation performed in Step S207 of FIG. 9; and

FIG. 12 is a flowchart illustrating an operation of an information processing apparatus according to a third exemplary embodiment.

### DETAILED DESCRIPTION

Configuration of Information Processing Apparatus 10

Hereinafter, an exemplary embodiment of the present invention will be described in detail with reference to the accompanying drawings.

Description of Entire Information Processing System

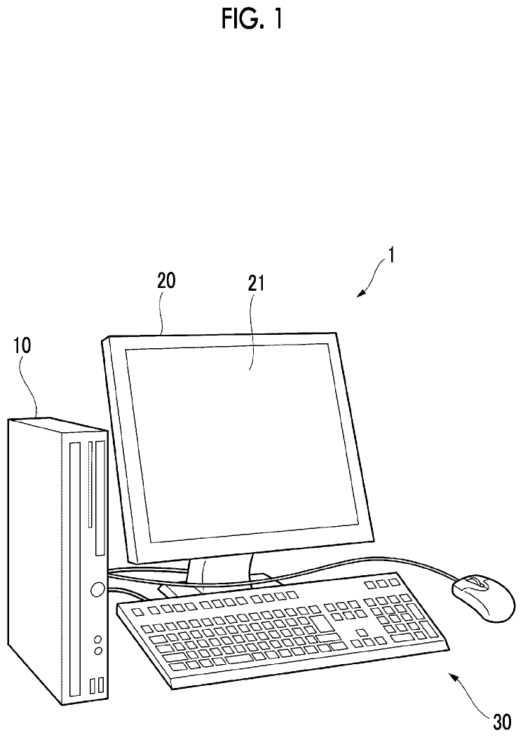

FIG. 1 is a diagram showing a configuration example of an information processing system 1 according to the present exemplary embodiment.

As shown in FIG. 1, the information processing system 1 of the present exemplary embodiment includes an information processing apparatus 10 that performs a control for creating and displaying image information for displaying an image on a display device 20, a display device 20 to which the image information created by the information processing apparatus 10 is input and which displays the image based on the image information, and an input device 30 for a user to input various kinds of information to the information processing apparatus 10.

The information processing apparatus 10 is, for example, a so-called desktop personal computer (PC). The information processing apparatus 10 creates image information by operating various kinds of application software under the control of an operating system (OS).

The display device 20 is an example of a display having a display screen 21 for displaying a screen. The display device 20 is composed of, for example, a liquid crystal display for a PC, a liquid crystal television, or a projector, which has a function of displaying an image by additive color mixing. Therefore, a display system in the display device 20 is not limited to a liquid crystal system. In the example shown in FIG. 1, the display screen 21 is provided inside the display device 20, but in a case where a projector, for example, is used as the display device 20, the display screen 21 is a screen or the like provided outside the display device 20.

In addition, the display device 20 of the present exemplary embodiment is a touch monitor. In this case, a touch panel is used as the display screen 21. In this case, image information is created by the information processing apparatus 10, and an image is displayed on the touch monitor based on the image information. Then, the user inputs an instruction for required processing by touching the touch monitor.

The input device 30 is composed of a keyboard, a mouse, a trackball, a touch pad, a trackpad, or the like. The input device 30 is used by the user to input an instruction for processing required by the user to the information processing apparatus 10 in a case of starting and terminating application software for performing image processing, or in a case of performing image processing, which will be described below in detail. That is, in the information processing system 1 of the present exemplary embodiment, the user can input an instruction by both touching the display screen 21 and operating the input device 30.

The information processing apparatus 10 and the display device 20 are connected to each other via a digital visual interface (DVI). Alternatively, the information processing apparatus 10 and the display device 20 maybe connected to each other via High-Definition Multimedia Interface (HDMI; registered trademark), DisplayPort, or the like, in place of the DVI.

In addition, the information processing apparatus 10 and the input device 30 are connected to each other via, for example, a universal serial bus (USB). Alternatively, the information processing apparatus 10 and the input device 30 may be connected to each other via IEEE1394, RS-232C, or the like, in place of the USB.

The information processing system 1 in the present exemplary embodiment is not limited to the embodiment shown in FIG. 1. For example, as the information processing system 1, a notebook type PC can be exemplified. In this case, the information processing apparatus 10, the display device 20, and the input device 30 are integrated as one PC.

As the information processing system 1, a smartphone or a tablet terminal can be exemplified. In this case, the tablet terminal includes a touch panel, and an image is displayed and an instruction from the user is input through the touch panel. That is, the touch panel functions as the display device 20 and the input device 30.

Configuration of Information Processing Apparatus 10

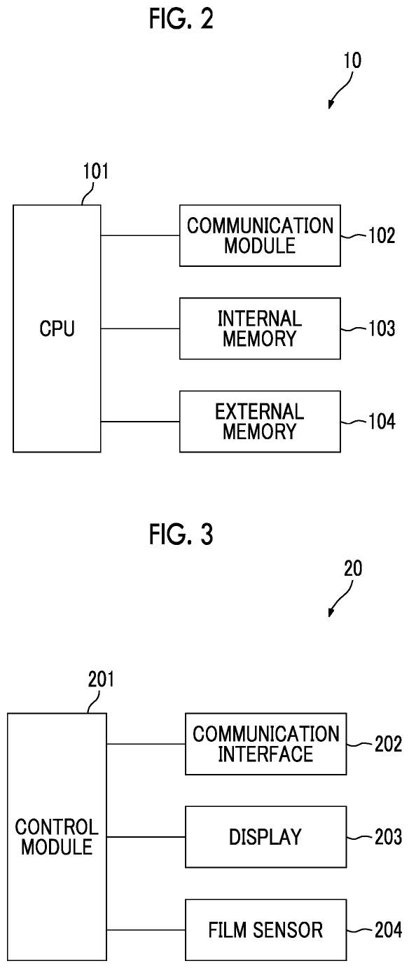

FIG. 2 is a diagram showing a hardware configuration of the information processing apparatus 10.

The illustrated information processing apparatus 10 includes a central processing unit (CPU) 101 that controls each unit through execution of a program, a communication module 102 used for communication with an external device, an internal memory 103 in which system data and internal data are stored, and an external memory 104 serving as an auxiliary memory.

The CPU 101 is an example of a processor, and executes programs such as an OS (basic software) and application software.

In a case of the present exemplary embodiment, the internal memory 103 and the external memory 104 are semiconductor memories. The internal memory 103 has a read only memory (ROM) in which a basic input output system (BIOS) or the like is stored, and a random access memory (RAM) used as a main memory. The CPU 101 and the internal memory 103 constitute a computer. The CPU 101 uses the RAM as a work space for the program. The external memory 104 is a storage such as a hard disk drive (HDD) or a solid state drive (SSD), and stores firmware, application software, and the like.

The communication module 102 is a communication interface for communication with the outside.

Configuration of Display Device 20

FIG. 3 is a diagram showing a hardware configuration of the display device 20.

The illustrated display device 20 includes a control module 201 that controls a display operation of the display device 20, a communication interface 202 that receives an image signal from the information processing apparatus 10, a display 203 that displays an image, and a film sensor 204 that detects a touch operation on the display 203.

The control module 201 generates a drive signal for driving the display 203 based on the image signal received by the communication interface 202, and displays a screen on the display 203.

In addition to the reception of the image signal from the information processing apparatus 10, the communication interface 202 transmits, in a case where the operation of the user is detected by the film sensor 204, coordinate information of a position of the operation to the information processing apparatus 10.

The display 203 is composed of, for example, an organic electro luminescent (EL) display or a liquid crystal display. In the present exemplary embodiment, an image or other information is displayed on a surface of the display 203.

The film sensor 204 is disposed on the surface of the display 203. The film sensor 204 has a characteristic of causing no interference with observation of the information displayed on the display 203, and detects, by a change in capacitance, the position where the user performs the operation.

The display screen 21 is composed of the display 203 and the film sensor 204. With this configuration, the display screen 21 of the present exemplary embodiment has a function as a touch panel, and can perform both touch operation and pointing operation. That is, in the display screen 21, the user can operate an object or the like displayed on the display screen 21 by touching the display screen 21. In addition, the user can perform the same operation by moving a cursor or the like displayed on the display screen 21 to a position of the object or the like by using the input device 30 and performing click or drag. Here, the term “object” refers to a target (operation target) that is displayed on the display screen 21 and operated by the user. Examples of the object include a check box, a menu, an icon, a window, a dialog box, and a button.

The OS running on the information processing apparatus 10 is also configured to be able to realize a so-called hybrid UI that supports both the touch operation and the pointing operation.

In this case, a detailed operation is difficult in the touch operation, and a quick operation is difficult in the pointing operation. Therefore, the user may want to perform a work by using these operations in combination. However, in a case where these operations are to be used in combination, the number of times a user's hand moves between the display screen 21 and the input device 30 increases. As a result, a moving distance of the user's hand increases, and the work tends to be inefficient. Further, a burden on the user increases, and the user feels tired.

In order to address this problem, it is considered that an area of a part of the display screen 21 is set as a trackpad area and the area is used for the pointing operation. That is, a virtual trackpad is displayed on the display screen 21, and in a case where the user wants to perform the pointing operation, the user operates the virtual trackpad. In addition, in a case where the user wants to perform the touch operation, the user touches the display screen 21. A virtual trackpad Tp is an example of a virtual pointing device. Here, the term “virtual pointing device” refers to a device that realizes this function by virtually displaying, on the display screen 21, input equipment that designates an input position and coordinates on the display screen 21.

In the configuration, the touch operation and the pointing operation can be used in combination on the display screen 21. As a result, the moving distance of the user's hand is reduced, and the work tends to be efficient. Further, the burden on the user is reduced, and the user is less likely to get tired. In this case, the information processing apparatus 10 performs a control for displaying a virtual trackpad that is displayed by occupying a predetermined area on the display screen 21 and an object that can be operated by both the user's touch and the virtual trackpad on the display screen 21.

However, with this method, the user cannot perform a touch operation on an object existing in the trackpad area. That is, in a case where the virtual trackpad and the object are displayed on the display screen 21 in an overlapping manner, the object is hidden by the virtual trackpad, and the user cannot perform the touch operation on the object.

Therefore, in the present exemplary embodiment, the information processing apparatus 10 has the following configuration to address this problem. Specifically, in a case where the trackpad area and the object are displayed on the display screen 21 in an overlapping manner and the user cannot operate the object, change is made such that the object is not to be in a state where the object cannot be operated. This matter will be described in detail below.

### First Exemplary Embodiment

Here, first, a first exemplary embodiment of the information processing apparatus 10 will be described. In the first exemplary embodiment, the CPU 101 changes a position where the virtual trackpad is displayed to a position where the virtual trackpad does not overlap the object.

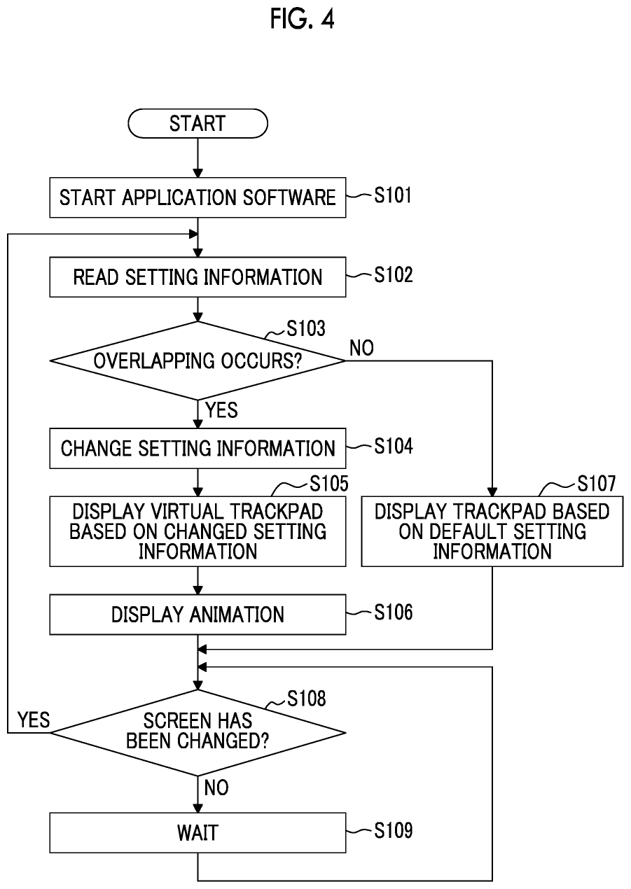

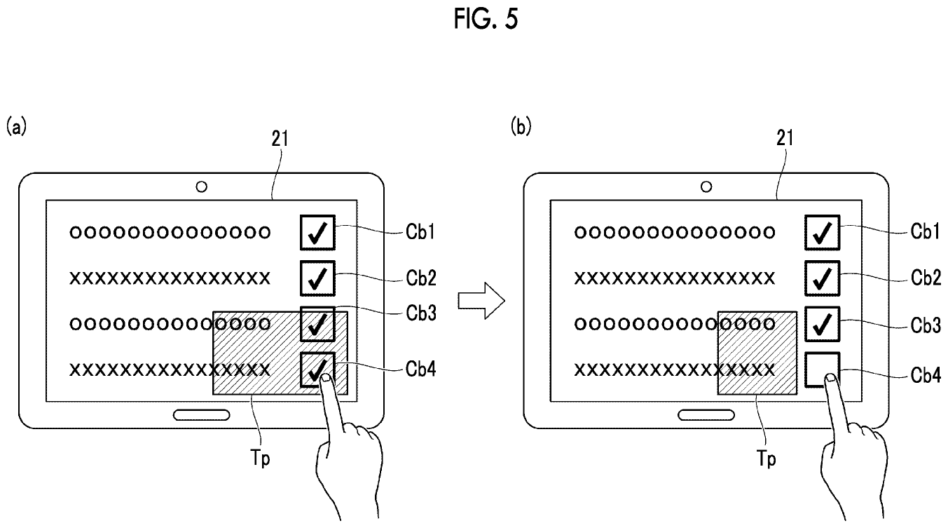

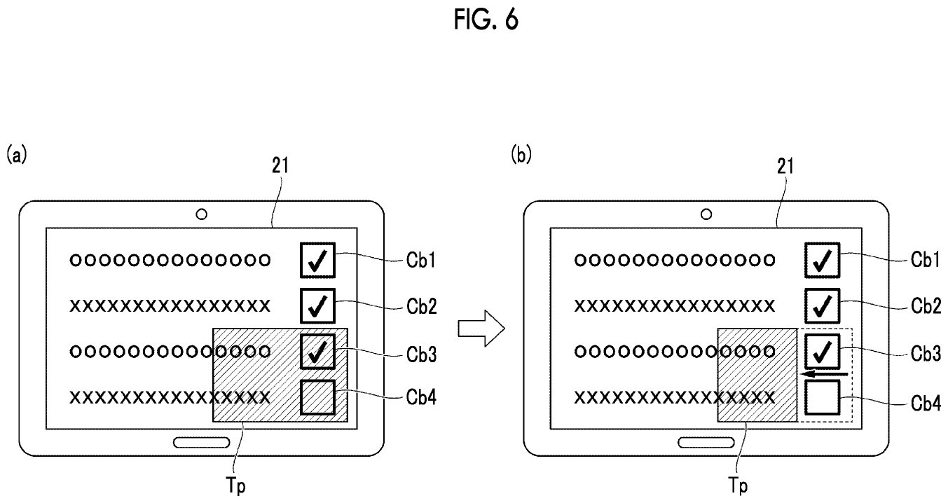

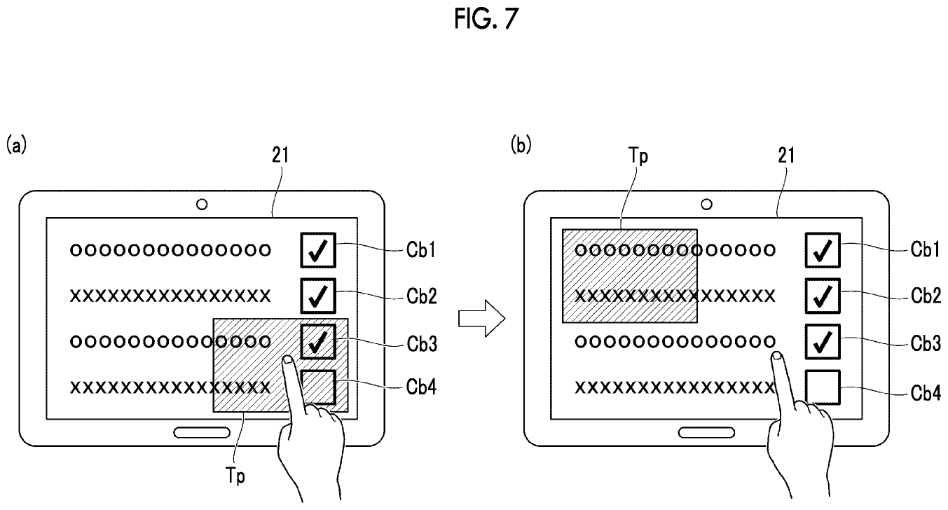

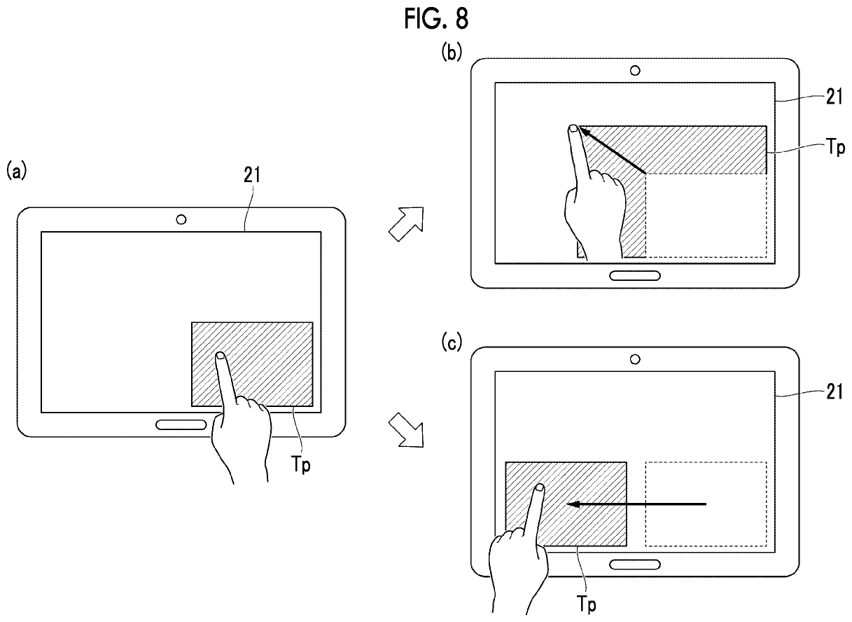

FIG. 4 is a flowchart illustrating an operation of the information processing apparatus 10 according to the first exemplary embodiment.

First, the CPU 101 starts application software according to an instruction from the user (Step S101).

Next, the CPU 101 reads, from an external memory 107, setting information of a position and a size and setting information of a control method to be applied for the virtual trackpad to be displayed (Step S102).

Then, the CPU 101 determines whether or not the positions of the object and the virtual trackpad overlap each other on a screen of the application software (Step S103).

As a result, in a case where the positions overlap each other (Yes in Step S103), the CPU 101 changes the setting information of the position or the size of the virtual trackpad so that the object is avoided (Step S104). In this case, for example, the size of the virtual trackpad Tp is reduced so that the virtual trackpad Tp does not overlap the position of the object.

Then, the virtual trackpad is displayed on the display screen 21 based on the changed setting information (Step S105). In addition, in a case where the size of the virtual trackpad is reduced, the CPU 101 displays an animation that indicates a shift from the size before the change to the size after the change (Step S106).

On the other hand, in a case where the positions do not overlap each other (No in Step S103), the trackpad is displayed on the display screen 21 based on the default setting information read in Step S102 (Step S107).

Next, the CPU 101 determines whether or not the screen of the application software has been changed based on a result of the operation of the user (Step S108).

As a result, in a case where the screen has been changed (Yes in Step S108), the process returns to Step S102.

On the other hand, in a case where the screen has not been changed (No in Step S108), the CPU 101 waits (Step S109), and the process returns to Step S108.

A part (a) and a part (b) in FIG. 5 are diagrams showing the processes performed in Steps S103 to S105 of FIG. 4.

The part (a) in FIG. 5 shows a state where the positions of the object and the virtual trackpad overlap each other.

In this case, the virtual trackpad Tp and check boxes Cb3 and Cb4 as the objects overlap each other and are displayed on the display screen 21. By touching an area where the virtual trackpad Tp is displayed, the same operation as an actual trackpad is realized. In this case, since check boxes Cb1 and Cb2 do not overlap the virtual trackpad Tp, the user can perform the operation by touching, but the check boxes Cb3 and Cb4 cannot be operated by touching because the check boxes Cb3 and Cb4 are hidden by the virtual trackpad Tp.

On the other hand, the part (b) in FIG. 5 is a diagram showing a case where the size of the virtual trackpad Tp is reduced in Step S104 of FIG. 4.

In this case, the positions of the virtual trackpad Tp and the check boxes Cb3 and Cb4 do not overlap each other. In this case, since the check boxes Cb3 and Cb4 are not hidden by the virtual trackpad Tp, the user may perform the operation by touching.

A part (a) and a part (b) in FIG. 6 are diagrams showing the process performed in Step S106 of FIG. 4.

Here, a case of displaying an animation that indicates a transition from a state of the part (a) in FIG. 6 to a state of the part (b) in FIG. 6 is shown.

The part (a) in FIG. 6 shows the virtual trackpad Tp whose size has not been changed. The part (b) in FIG. 6 shows the virtual trackpad Tp whose size has been changed. Then, by displaying the animation that indicates the transition from the state of the part (a) in FIG. 6 to the state of the part (b) in FIG. 6, the user is notified that the position of the virtual trackpad Tp has been changed. In this case, an animation in which the virtual trackpad Tp shrinks from the state of the part (a) in FIG. 6 to the state of the part (b) in FIG. 6 is displayed.

In the above-described example, the area for displaying the virtual trackpad Tp is reduced to an area that does not overlap the position of the object, but limitation is not made to this.

A part (a) and a part (b) in FIG. 7 are diagrams showing another example of the first exemplary embodiment.

Here, as shown in the part (a) in FIG. 7, first, in a case where the user views the display screen 21, the virtual trackpad Tp is displayed in a first area relatively close to the right side and the lower side on the display screen 21. That is, the virtual trackpad Tp is displayed at a position close to the lower right from the center on the display screen 21. This is because, since the user is right-handed in many cases, the display on the right side of the display screen 21 is convenient for the user during the operation, and the display on the lower side of the display screen 21 is convenient for the user during the operation. In a case where the area of the virtual trackpad Tp and the position of the object overlap each other, the CPU 101 changes the virtual trackpad Tp to a second area different from the first area.

The part (b) in FIG. 7 is a diagram showing the virtual trackpad Tp whose position has been moved to the second area. Here, the virtual trackpad Tp is moved to a position where the object is not displayed, for example, a position on the upper left on the display screen 21. In addition, the virtual trackpad Tp may be moved in the first area.

Note that the position where the virtual trackpad Tp is displayed and the size of the virtual trackpad Tp may be set by the user.

A part (a), a part (b), and a part (c) in FIG. 8 are diagrams showing a case where the user sets the position where the virtual trackpad Tp is displayed and the size of the virtual trackpad Tp.

The part (a) in FIG. 8 is a diagram showing a default position of the virtual trackpad Tp, and as in the part (a) in FIG. 7, the virtual trackpad Tp is displayed at a position relatively close to the right side and the lower side on the display screen 21.

In this case, in a case where the user wants to make the virtual trackpad Tp large, as shown in the part (b) in FIG. 8, the user touches an upper left vertex portion of the rectangular virtual trackpad Tp and moves the portion to the upper left side. Thus, the virtual trackpad Tp can be set to be large. The virtual trackpad Tp can be set to be small by the operation of touching the upper left vertex portion of the virtual trackpad Tp and the operation of moving the portion to the lower right side. In addition, the same operation can be realized by using other vertices of the virtual trackpad Tp.

In addition, there is a case where the user is, for example, left-handed and wants to display the virtual trackpad Tp at a position relatively close to the left side and the lower side on the display screen 21. In this case, as shown in the part (c) in FIG. 8, the user touches a point in the rectangular virtual trackpad Tp and moves the point to the left side on the display screen 21. Thus, setting of moving the position where the virtual trackpad Tp is displayed can be made. By the same operation, the position where the virtual trackpad Tp is displayed may be moved to any location on the display screen 21.

As described above, in the first exemplary embodiment, the CPU 101 performs a control for displaying the virtual pointing device at a predetermined position on the display screen 21 with a predetermined size. In this case, in a case where the virtual pointing device and the object are displayed on the display screen 21 in an overlapping manner, the CPU 101 changes the position where the virtual pointing device Tp is displayed or the size of the virtual pointing device Tp.

### Second Exemplary Embodiment

Next, a second exemplary embodiment of the information processing apparatus 10 will be described. In the second exemplary embodiment, the CPU 101 changes the operation on the virtual trackpad Tp and the operation on the object such that the operations are different from each other.

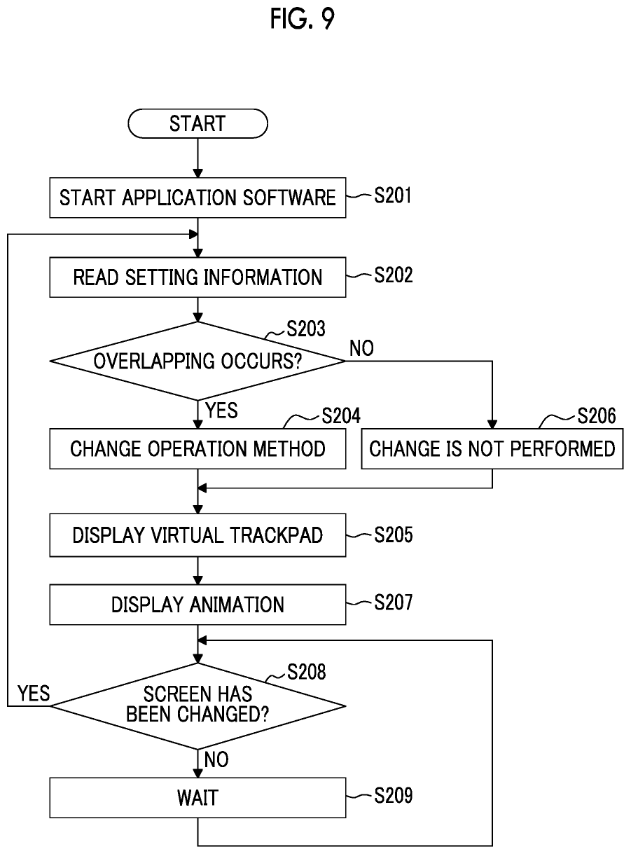

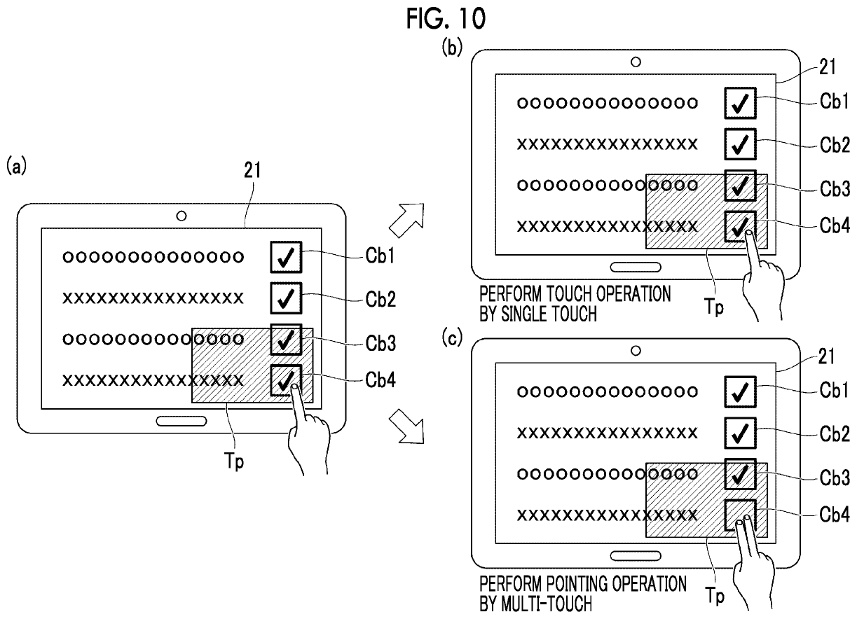

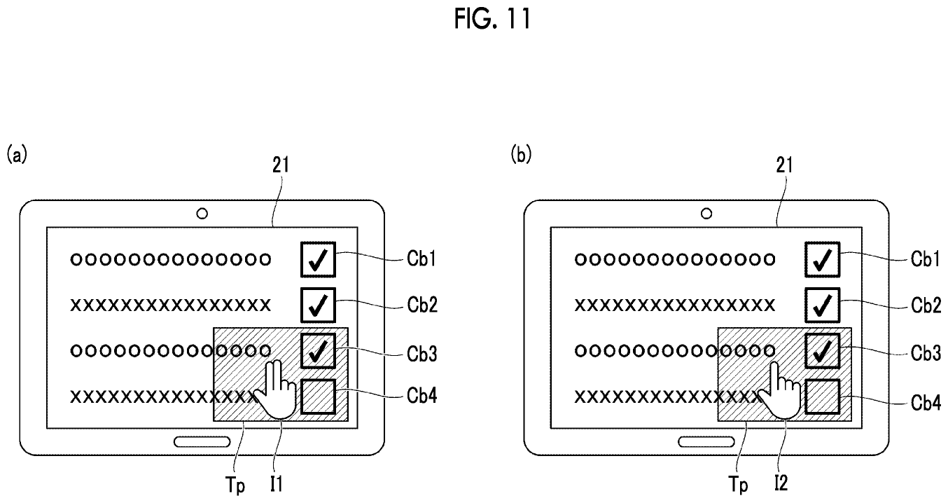

FIG. 9 is a flowchart illustrating an operation of the information processing apparatus 10 according to the second exemplary embodiment.

In FIG. 9, Steps S201 to S203 and Steps S208 and S209 are the same as Steps S101 to S103 and Steps S108 and S109 in FIG. 4. Thus, the description thereof will be omitted.

In the second exemplary embodiment, in a case where the positions of the object and the virtual trackpad overlap each other in Step S203 (Yes in Step S203), the operation on the virtual trackpad Tp and the operation on the object are changed so as to be different from each other (Step S204). That is, the CPU 101 changes the operation method performed by the user such that the operation method is different between a case of the virtual trackpad Tp and a case of the object. Then, the virtual trackpad is displayed on the display screen 21 based on the setting information read in Step S202 (Step S205).

On the other hand, in a case where the positions do not overlap each other (No in Step S203), such a change is not performed (Step S206), and the virtual trackpad is displayed on the display screen 21 based on the setting information read in Step S202 (Step S205).

Then, the CPU 101 displays an animation about the operation method for the virtual trackpad Tp (Step S207).

A part (a), a part (b), and a part (c) in FIG. 10 are diagrams showing the process performed in Step S204 of FIG. 9.

The part (a) in FIG. 10 is the same as the part (a) in FIG. 5, and shows a case where the check boxes Cb3 and Cb4 as the objects and the virtual trackpad Tp overlap each other and are displayed on the display screen 21. In this case, the check boxes Cb3 and Cb4 cannot be operated since the check boxes Cb3 and Cb4 are hidden by the virtual trackpad Tp.

In this case, here, the operation on the virtual trackpad Tp and the operation on the object are different touch operations. Specifically, the operation method for the virtual trackpad Tp is changed from default setting.

As shown in the part (b) in FIG. 10, the operation on the object is left as a default single touch. That is, in a case where there is only one touch in an area where the virtual trackpad Tp and the object overlap each other, the CPU 101 determines that the operation on the object is made. As a result, the user can perform the touch operation on the check boxes Cb3 and Cb4 as the objects by the single touch.

On the other hand, as shown in the part (c) in FIG. 10, the operation on the virtual trackpad Tp is changed from the single touch to a multi-touch. That is, in a case where there are two or more touches in the area where the virtual trackpad Tp and the object overlap each other, the CPU 101 determines that the operation on the virtual trackpad Tp is made. That is, in the operation method for the virtual trackpad Tp, the setting is changed from the single touch to the multi-touch by default. As a result, the user can perform the pointing operation using the virtual trackpad Tp by the multi-touch.

A part (a) and a part (b) in FIG. 11 are diagrams showing the animation performed in Step S207 of FIG. 9.

The part (a) in FIG. 11 shows a case where an icon I1 is displayed as an animation in a case where the operation on the virtual trackpad Tp has been changed from the single touch to the multi-touch. The icon I1 is an icon indicating a state where an index finger and a middle finger are extended, and informs the user that the virtual trackpad Tp needs to be operated with two fingers.

On the other hand, the part (b) in FIG. 11 shows a case where an icon I2 is displayed as an animation in a case where the operation on the virtual trackpad Tp remains in the single touch state. The icon I2 is an icon indicating a state where an index finger is extended, and informs the user that the virtual trackpad Tp can be operated with one finger.

In the above-described example, although the operation method for the virtual trackpad Tp is changed from the default setting, the operation method for the object may be changed from the default setting. In addition, the operation method such as touching the object by the user is an example of a first contact which is a contact with the object. In addition, the operation method such as touching the virtual trackpad Tp by the user is an example of a second contact which is a contact with the virtual trackpad Tp.

As described above, in the second exemplary embodiment, the CPU 101 performs a control for displaying the virtual pointing device at a predetermined position on the display screen 21 with a predetermined size. In this case, in a case where the virtual pointing device and the object are displayed on the display screen 21 in an overlapping manner, the CPU 101 changes any one of the first contact or the second contact in a case where the first contact and the second contact are the same.

### Third Exemplary Embodiment

Next, a third exemplary embodiment of the information processing apparatus 10 will be described. In the third exemplary embodiment, the first exemplary embodiment and the second exemplary embodiment are used in combination. Here, the first exemplary embodiment and the second exemplary embodiment are used properly depending on the type of the object. Specifically, the change of the virtual trackpad Tp is different in response to the operation that the user is requested to perform depending on the type of the object.

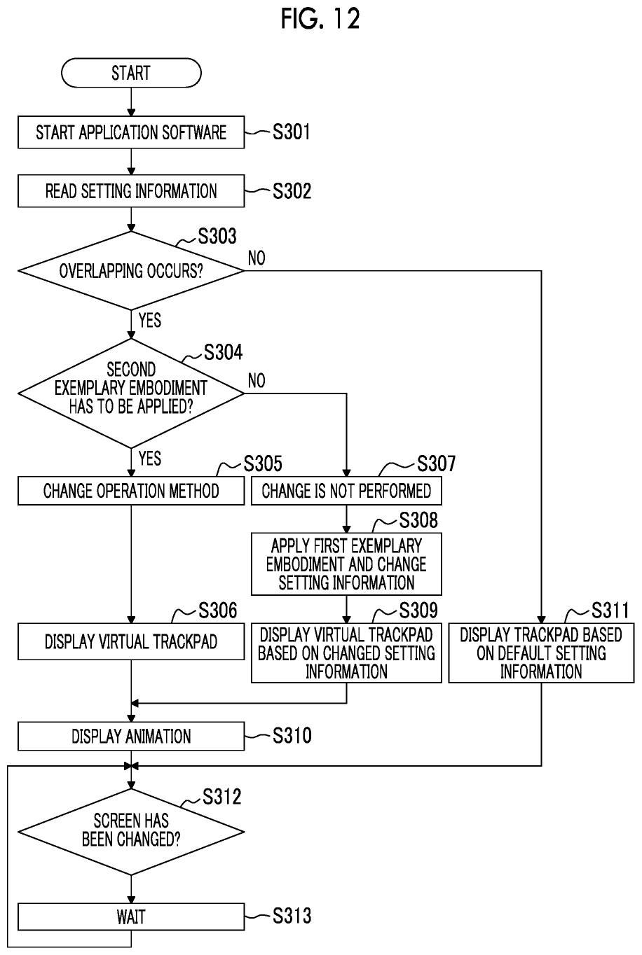

FIG. 12 is a flowchart illustrating an operation of the information processing apparatus 10 according to the third exemplary embodiment.

In FIG. 12, Steps S301 to S303 and Steps S312 and S313 are the same as Steps S101 to S103 and Steps S108 and S109 in FIG. 4. Thus, the description thereof will be omitted.

In the third exemplary embodiment, in a case where the positions of the object and the virtual trackpad overlap each other in Step S303 (Yes in Step S303), the CPU 101 determines whether or not the overlapping object is a target to which the second exemplary embodiment has to be applied (Step S304).

In this case, the object being a target of application may occupy a large area on the display screen 21, for example. In this case, it may be difficult to avoid overlapping between the virtual trackpad Tp and the object as in the first exemplary embodiment. Ina case of such an object, the CPU 101 determines that the object is a target to which the second exemplary embodiment has to be applied. On the other hand, in a case where the object occupies only a small area on the display screen 21, the CPU 101 determines that the object is not a target to which the second exemplary embodiment has to be applied but a target to which the following first exemplary embodiment has to be applied.

In addition, even in a case where a plurality of objects exist and are disposed throughout the display screen 21, it may be difficult to avoid overlapping between the virtual trackpad Tp and the object. The same can be said in this case.

Further, the user can also set which of the first exemplary embodiment and the second exemplary embodiment has to be used. In this case, in a case where the user has made setting to apply the first exemplary embodiment and not to apply the second exemplary embodiment, the CPU 101 determines that the second exemplary embodiment has to be applied. In this case, in a case where the user has made setting to apply the second exemplary embodiment and not to apply the first exemplary embodiment, the CPU 101 determines that the second exemplary embodiment has not to be applied.

In a case where the CPU 101 determines in Step S304 that the object is a target to which the second exemplary embodiment has to be applied (Yes in Step S304), the operation on the virtual trackpad Tp and the operation on the object are changed so as to be different from each other (Step S305). In this case, the operation method for the virtual trackpad Tp is changed. Specifically, for example, as described above, the operation setting for the virtual trackpad Tp is changed from the single touch to the multi-touch. The operation on the object is left as the single touch.

Then, the virtual trackpad Tp is displayed based on the setting information read in Step S302 (Step S306). After that, the process proceeds to Step S310 and the animation is displayed (Step S310). This animation is as shown in FIG. 11. After that, the process proceeds to Step S312.

On the other hand, in a case where the CPU 101 determines that the object is not a target to which the second exemplary embodiment has to be applied (No in Step S304), such a change is not performed, and the operation setting for the virtual trackpad Tp is set as a default operation method (Step S307). That is, the operation is left as the single touch.

Then, the CPU 101 determines that the first exemplary embodiment has to be applied, and changes the setting information (Step S308). Specifically, as described above, setting is performed to reduce the area for displaying the virtual trackpad Tp to an area that does not overlap the position of the object.

Then, the virtual trackpad Tp is displayed on the display screen 21 based on the changed setting information (Step S309). That is, the virtual trackpad Tp is displayed on the display screen 21 with the changed size. In this case, the CPU 101 displays an animation that indicates a shift from the size before the change to the size after the change (Step S310). This animation is as shown in FIG. 5. After that, the process proceeds to Step S312.

In addition, in a case where the positions do not overlap each other in Step S303 (No in Step S303), the virtual trackpad Tp is displayed on the display screen 21 based on the default setting information read in Step S302 (Step S311).

According to the embodiment described in detail above, the touch operation and the pointing operation can be used in combination on the display screen 21, and the moving distance of the user's hand is reduced. As a result, the effect of facilitating the work efficiency and reducing the burden on the user can be maintained. Even in this case, the user is prevented from being unable to perform the touch operation on the object existing in the area where the virtual trackpad Tp is displayed.

Although the virtual trackpad Tp is shown as a virtual pointing device in the above example, limitation is not made to this, and any embodiment or name of the virtual trackpad Tp may be used as long as the pointing operation can be performed.

In addition, instead of the information processing apparatus 10, a server device such as a cloud server disposed on a cloud may be used, and an image may be displayed on the display device 20 based on image information sent from the server device.

Description of Program

Here, processing performed by the information processing apparatus 10 according to the present exemplary embodiment described above is performed by, for example, a program such as application software.

Accordingly, a program realizing the processing performed by the information processing apparatus 10 in the present exemplary embodiment can be regarded as a program causing a computer to execute a process including: realizing a function of displaying an object to be operated on a display screen, a function of receiving an operation on the object by a first contact that is a contact with the object and a second contact that is a contact with a virtual pointing device by a user, and a function of displaying the virtual pointing device at a predetermined position of the display screen with a predetermined size; and changing at least one of the predetermined position, the predetermined size, the first contact, or the second contact, in a case where the virtual pointing device and the object are displayed on the display screen in an overlapping manner.

The program realizing the present exemplary embodiment can be provided not only by communication means but also by being stored in a recording medium such as a CD-ROM.

Although the present exemplary embodiment has been described above, the technical scope of the present invention is not limited to the scope described in the above exemplary embodiment. It is obvious from the description of the claims that various modifications or improvements to the above-described exemplary embodiments are also included in the technical scope of the present invention.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing apparatus comprising:
a processor configured to:
perform a control for displaying an object to be operated on a display screen, a control for receiving an operation on the object by a first contact that is a contact with the object and a second contact that is a contact with a virtual pointing device used for a pointing operation of the object by a user, and a control for displaying the virtual pointing device at a predetermined position of the display screen with a predetermined size; and
change at least one of the predetermined position, the predetermined size, the first contact, or the second contact, in a case where the virtual pointing device and the object are displayed on the display screen in an overlapping manner.

2. The information processing apparatus according to claim 1,
wherein the change is to change the predetermined position to a position where the virtual pointing device does not overlap the object.

3. The information processing apparatus according to claim 1,
wherein the change is to change the predetermined size so that the virtual pointing device does not overlap a position of the object.

4. The information processing apparatus according to claim 3, wherein the processor is configured to:
display an animation that indicates a shift from a size before the change to a size after the change in a case where the predetermined size is reduced.

5. The information processing apparatus according to claim 2,
wherein the predetermined position is located in a first area relatively close to a right side and a lower side on the display screen in a case where the user views the display screen, and
the change is to change a position of the virtual pointing device to a position different from the predetermined position in the first area.

6. The information processing apparatus according to claim 1,
wherein the predetermined position and the predetermined size are settable by the user.

7. The information processing apparatus according to claim 1,
wherein the change is to change any one of the first contact or the second contact in a case where the first contact and the second contact are the same.

8. The information processing apparatus according to claim 1,
wherein a method of the change is different depending on a type of the object.

9. The information processing apparatus according to claim 8,
wherein the method of the change is different in response to an operation that the user is requested to perform depending on the type of the object.

10. An information processing system comprising:
an information processing apparatus that creates image information; and
a display having a display screen for displaying a screen based on the image information created by the information processing apparatus,
wherein the information processing apparatus includes a processor configured to:
perform control for displaying an object to be operated on the display screen, control for receiving an operation on the object by a first contact that is a contact with the object and a second contact that is a contact with a virtual pointing device used for a pointing operation of the object by a user, and control for displaying the virtual pointing device at a predetermined position of the display screen with a predetermined size; and
change at least one of the predetermined position, the predetermined size, the first contact, or the second contact, in a case where the virtual pointing device and the object are displayed on the display screen in an overlapping manner.

11. A non-transitory computer readable medium storing a program causing a computer to execute a process comprising:
realizing a function of displaying an object to be operated on a display screen, a function of receiving an operation on the object by a first contact that is a contact with the object and a second contact that is a contact with a virtual pointing device used for a pointing operation of the object by a user, and a function of displaying the virtual pointing device at a predetermined position of the display screen with a predetermined size; and
changing at least one of the predetermined position, the predetermined size, the first contact, or the second contact, in a case where the virtual pointing device and the object are displayed on the display screen in an overlapping manner.

12. The information processing apparatus according to claim 1,
wherein the virtual pointing device is a virtual trackpad.

13. The information processing system according to claim 10,
wherein the virtual pointing device is a virtual trackpad.

14. The non-transitory computer readable medium according to claim 11,
wherein the virtual pointing device is a virtual trackpad.
